(19) United States
(12) Patent Application Publication
(10) Pub. No.: US 2024/0213501 A1
(43) Pub. Date: Jun. 27, 2024

(54) SEPARATOR PLATE FOR AN ELECTROCHEMICAL SYSTEM, HAVING A SUPPORTING BEAD

(71) Applicant: Reinz-Dichtungs-GmbH, Neu-Ulm (DE)

(72) Inventors: Manuel KAMM, Neu-Ulm (DE); Johannes KOEBELE, Neu-Ulm (DE); Harald REBIEN, Neu-Ulm (DE); Bernd GAUGLER, Neu-Ulm (DE); Felix SENF, Ulm (DE)

(21) Appl. No.: 18/391,469

(22) Filed: Dec. 20, 2023

(30) Foreign Application Priority Data
Dec. 21, 2022 (DE) 20 2022 107 165.9

(51) Int. Cl. H01M 8/0276; H01M 8/0247; H01M 8/0273; H01M 8/2465

(52) U.S. Cl. CPC H01M 8/0276; H01M 8/0247; H01M 8/0273; H01M 8/2465

(57) ABSTRACT

A separator plate for an electrochemical system and a bipolar plate comprising two such separator plates for an electrochemical system. An electrochemical system comprising at least two separator plates or one bipolar plate. A separator plate comprising a sealing bead for sealing off a region of the separator plate, the sealing bead having at least in sections a wavy course with at least two wave periods and a supporting bead for supporting the sealing bead. The supporting bead is spaced apart from the sealing bead and extends along the wavy course of the sealing bead. The supporting bead has a periodically changing, non-vanishing width with at least two periods, the width of the supporting bead being measured perpendicular to the direction of extension of the supporting bead and from a first outer bead foot to a second outer bead foot of the supporting bead.

### CROSS-REFERENCE TO RELATED APPLICATION

The present application claims priority to German Utility Model Application No. 20 2022 107 165.9, entitled “SEPARATOR PLATE FOR AN ELECTROCHEMICAL SYSTEM, HAVING A SUPPORTING BEAD”, and filed Dec. 21, 2022. The entire contents of the above-listed application is hereby incorporated by reference for all purposes.

### TECHNICAL FIELD

The present disclosure relates to a separator plate for an electrochemical system and to a bipolar plate comprising two such separator plates for an electrochemical system. The present disclosure further relates to an electrochemical system comprising at least two separator plates or one bipolar plate. The electrochemical system may be a fuel cell system, an electrochemical compressor, a redox flow battery, or an electrolyzer.

### BACKGROUND AND SUMMARY

Known electrochemical systems usually comprise a stack of electrochemical cells which are separated from each other by bipolar plates. Dimensionally stable and structurally rigid end plates are usually arranged at both ends of the stack. Such bipolar plates may serve, for example, for indirectly electrically contacting the electrodes of the individual electrochemical cells (for example fuel cells) and/or for electrically connecting adjacent cells (series connection of the cells). The bipolar plates are typically formed of two individual plates which are joined together, these being referred to hereinafter as separator plates. The separator plates of the bipolar plate may be joined together in a materially bonded manner, for example by one or more welded joints, for instance by one or more laser-welded joints. While bipolar plates composed of two separator plates are almost always used in fuel cell systems, it is possible for both two-layer bipolar plates and single-layer separator plates to be used instead of bipolar plates in the other electrochemical systems mentioned.

The electrochemical cells typically also include in each case one or more membrane electrode assemblies (MEAs). In addition to the actual membranes and the catalyst layers and electrodes, the MEAs may each have one or more gas diffusion layers (GDLs), which are usually oriented towards the bipolar plates and are formed, for example, as a metal or carbon fleece. Each of the membrane electrode assemblies also includes a reinforcing border/frame, which surrounds the actual membrane.

The bipolar plates or the individual separator plates may each have or form structures which are designed, for example, to supply one or more reaction media to the electrochemical cells bounded by adjacent bipolar plates and/or to convey reaction products away therefrom. The media may be fuels (for example hydrogen or methanol) or reaction gases (for example air or oxygen).

The bipolar plates or the separator plates may also have structures for guiding a cooling medium through the bipolar plate, for example through a cavity enclosed by the two separator plates of a two-layer bipolar plate. The bipolar plates may additionally be designed to transfer the waste heat generated during the conversion of electrical or chemical energy in the electrochemical cell and to seal off the different media channels and/or cooling channels with respect to each other and/or with respect to the outside. The reaction media, reaction products and the fresh or heated cooling medium can be grouped together under the term “media”.

Furthermore, the bipolar plates or the individual separator plates usually each have a plurality of through-openings. Through the through-openings, the media can be routed in the stacking direction towards the electrochemical cells bounded by adjacent separator plates of the stack or into the cavity formed by the separator plates of the bipolar plate, or can be routed out of the cells or out of the cavity. Furthermore, the separator plates may also have channel structures for supplying one or more media to an active region of the electrochemical cell and/or for conveying media away therefrom. To this end, for each medium, at least two through-openings—at least one inlet opening and at least one outlet opening—may be fluidically connected to each other via a distribution region, a flow region and a collection region. The flow region may be located opposite the electrochemically active region of the cell. The distribution region, flow region and collection region may each have channel structures for guiding media.

The sealing between the bipolar plates and the membrane electrode assembly or between a separator plate and a membrane electrode assembly usually takes place by way of sealing elements arranged outside of the electrochemically active region and usually comprises both at least one port seal, which is arranged around a through-opening, and an outer seal (perimeter sealing element), wherein the sealing elements may be designed as sealing beads.

In order for the sealing elements to be able to achieve a consistently good sealing effect regardless of the respectively prevailing operating state. The sealing elements may be elastically deformable, e.g. reversibly deformable, at least within a specified tolerance range. However, if the sealing elements are deformed beyond the tolerance range, plastic deformations, e.g. irreversible deformations, of the sealing elements may occur. This may lead to the sealing elements no longer being able to fulfil their sealing effect. This can significantly reduce the efficiency of the system or even make it completely impossible to maintain operation of the system. If the system is operated with highly flammable media, such as hydrogen for example, or if such media are produced during operation, damage to the sealing elements may even pose a major safety risk. Irreversible deformation of the sealing elements of the bipolar plates or separator plates may be caused, for example, as a result of significant mechanical forces suddenly acting on the plate stack, as may occur in the event of a car accident for example. If the bipolar plates are installed horizontally, e.g. with a vertical stacking direction, excessive mechanical force may also occur on the plate stack when driving on extremely uneven terrain, as well as in the case of large potholes or the like. However, significant mechanical forces may suddenly occur even before a plate stack is installed, for example in the event of an accident during transportation of the stack to its installation site.

When such an electrochemical cell is subjected to a force impact, for example due to a collision, the sealing elements may sometimes undergo considerable deformations. Due to the inertia of the components and of the media guided therein, such as the coolant, during the collision, an excessive force occurs on the sealing elements of the bipolar plates or separator plates in the direction of impact. This force may lead to permanent deformation of the sealing elements. During the actual collision, the forces may act strongly on the sealing elements of the separator plates that are located at a short distance from the force application point and are thus arranged closer to the end plate referred to as the first end plate. As the distance of the separator plates increases, the force acting on the sealing elements during the collision decreases. As the stack subsequently “rebounds”, the sealing elements of the unloaded separator plates on the side remote from the impact are abruptly compressed as a result of striking against the second end plate, the forces here being greater as the distance of the separator plates from the site of impact increases. Both phenomena, which are comparable to a shock wave, may lead to a loss of sealing of the stack as a whole and may thus render it unusable.

The electrochemical system or the separator plates thereof may be provided with a supportive or protective mechanism which, to the greatest extent possible, protects the sealing elements against irreversible plastic deformations, even under the effect of significant mechanical forces.

One known solution provides for enclosing the electrochemical system in a protective container which has a high strength and good mechanical stability. However, in the event of an impact, an impulse transfer may occur which is so large that it cannot be absorbed and/or eliminated by the protective container; it is therefore transmitted to the plate stack in substantially unattenuated form. Furthermore, such a protective container is usually associated with additional costs, weight, installation space requirements and outlay on material, which are often undesirable, especially for mobile applications.

Other known solutions provide electronic switch-off mechanisms, but these merely interrupt flows of media and do not provide any protection against mechanical destruction.

It would therefore be desirable if an assembly could be created that can withstand the greatest possible mechanical loads and thus ensures the safest possible operation. The installation space requirement and the weight of the assembly sought should increase as little as possible or barely at all compared to the known solutions.

WO 2019/076813 A1 proposes pad-like shock absorbers for absorbing the impact energy, which are applied in the border region of the bipolar plate, for example by being placed or plugged thereon or adhesively bonded thereto. The application of these shock absorbers is therefore associated with additional effort and often with at least one additional manufacturing step. The same applies to pressure absorbers applied by printing or in the form of a film, such as those disclosed in US 2020/0388858. It would be desirable if production of the separator plate could be simplified.

The object of the present disclosure is therefore to develop a more robust separator plate, or a bipolar plate or an electrochemical cell comprising at least one separator plate, which at least partially solves the problems mentioned above.

The object is achieved by the subjects of the independent claims.

According to a first aspect, a separator plate for an electrochemical system is provided, having a separator plate plane. The separator plate comprises:
a sealing bead for sealing off a region of the separator plate, the sealing bead having at least in part a wavy course with at least two wave periods, and
a supporting bead for supporting the sealing bead, for instance in a crash situation or in the event of an impact.

The supporting bead is spaced apart from the sealing bead and extends along the wavy course of the sealing bead. The supporting bead has a periodically changing, non-vanishing width with at least two periods, the width of the supporting bead being measured perpendicular to the direction of extension of the supporting bead and from a first outer bead foot to a second outer bead foot of the supporting bead.

The impact above should also include situations involving an impact during handling (prior to installation), the application of an external force in general, and “improper” acceleration in general.

Compared to a sealing bead that extends rectilinearly, a wavy sealing bead may enable greater stiffness, even over a relatively long course of the sealing bead, such as of perimeter beads. In the case of port beads, too, however, a higher level of force is achieved by means of the wavy sealing bead. The adjacent yet spaced-apart course of the sealing bead and the supporting bead results in two elements which serve to bear adjacent components, such as the MEA or the reinforcing border thereof. When compressed under operating conditions, the sealing bead is usually compressed to such an extent that it has approximately the height corresponding to the non-compressed or minimally compressed height of the supporting bead. As a result, the sealing bead yields elastically under normal operating conditions and absorbs almost all of the force introduced by the clamping of the stack, while the supporting bead is subjected to only a small amount of force. The width periodicity of the supporting bead enables the stiffness of the supporting bead to be configured in a targeted manner, which has a significant influence on the force distribution between the sealing bead and the supporting bead and thus on the further deformation of the two elements under stronger compression, as may occur in the event of an impact. Compared to a supporting bead that extends linearly with a constant width, a supporting bead that periodically changes in width and takes up a comparable amount of space can be used to provide better support and thus to more effectively absorb compression energy in the event of excessive compression. Compared to supporting elements that consist only of spaced-apart nubs, a more even and improved supporting effect, e.g. a higher level of force, is achieved. Greater forces can therefore be absorbed before plastic deformations occur.

Optionally, the supporting bead comprises two bead flanks, which start from said bead feet, and a bead top, which extends between the bead flanks of the supporting bead. In the non-compressed state of the separator plate, the bead top may be substantially planar or convex relative to the separator plate plane in a first portion and may have at least one curvature relative to the separator plate plane in a second portion, said curvature being configured as a depression, indentation, or deformation in the bead top. Such a curvature enables further adjustment of the rigidity of the supporting bead, without taking up additional installation space. In one variant, at least one such curvature may have an incompressible elastomer-based filling on its concave side; in other variants, all the curvatures are free of such fillings, but they may still be coated in the same way as the rest of the surface of the separator plate.

Optionally, the width of the supporting bead may vary between a minimum width and a maximum width, the curvature being arranged in the region of the maximum width of the supporting bead and/or the bead top being planar or convex relative to the separator plate plane in the region of the minimum width. As a result, the stiffness of the supporting bead can be made uniform or configured otherwise in a targeted manner.

It may be provided that the curvature relative to the separator plate plane extends at most in a region spanned by a single period of the periodically changing width of the wavy course of the supporting bead. By way of example, a curvature may extend over a length that is between 10 and 80% of the period length of the supporting bead. Typically, in the case of one curvature per period length, the length of a curvature will be between 15% and 65% of the period length, with this curvature, for instance, extending centrally in the region of maximum width.

In some embodiments, the bead top has at least two curvatures relative to the separator plate plane, for example at least two curvatures per period of the width, said curvatures having different embossing depths and/or different dimensions and/or different geometric shapes. This may make it possible to adjust the stiffness of the supporting bead in a targeted manner, for example with regard to the application of different levels of force.

It may be provided that the curvature is at least in part spaced apart from the separator plate plane at least in a non-compressed state of the separator plate and/or at least in part lies in the separator plate plane in a compressed state of the separator plate. It may be provided that the curvature has a central region, wherein the central region is at least in part spaced apart from the separator plate plane at least in a non-compressed state of the separator plate and/or lies in the separator plate plane in a compressed state of the separator plate. In the non-compressed state, the curvature, for example the central region thereof, usually has a smaller height than the supporting bead, e.g. such as the bead flanks. In the non-compressed state, the height of the central region can be e.g. between 60% and 95%, and/or between 80% and 92% of the height of the supporting bead. By way of example, it is possible that only when the sealing bead is compressed beyond the compression under normal operating conditions, which has already led to an increased application of force to the supporting bead and thus deformation of the latter, the curvature will come to bear and will possibly also be deformed when further force is applied. In the case of other height gradations, for instance if there are at least two curvatures of different height, the curvature of greater height, referred to here as the first curvature, may already come to bear under normal operating conditions, while under greater compression the first curvature may then be compressed, and under stronger compression the curvature of smaller height, referred to here as the second curvature, may finally also come to bear and optionally may also be compressed.

The first bead flank of the supporting bead may face towards the sealing bead and may have a periodic and/or wavy course.

The second bead flank of the supporting bead may face away from the sealing bead and may have a periodic and/or wavy course or a rectilinear course. For example, it is possible that the two bead flanks of the supporting bead have a periodic and/or wavy course that is offset by 180° relative to each other, wherein the amplitude—measured in each case at the boundary line between the bead top and the relevant bead flank—may be lower on the side of the second bead flank than on the side of the first bead flank.

The wave periods of the sealing bead and the width periods of the supporting bead often have the same period length and/or the same phase and/or a phase shifted substantially by 180°. While the bead flanks of the sealing bead may extend in phase with each other, the bead flanks of the supporting bead may extend with a 180° phase shift relative to each other. As a result, it is possible that one bead flank of the supporting bead extends in phase with the bead flanks of the sealing bead, and the other bead flank of the supporting bead extends with a 180° phase shift relative to the bead flanks of the sealing bead. For example, the bead flank of the supporting bead that faces towards the sealing bead may extend in phase with the bead flanks of the sealing bead. This may enable efficient use of the installation space, but may also enable use of the supporting effect of the supporting bead for the sealing bead.

It may be provided that concave regions of the supporting bead face towards convex regions of the sealing bead and/or convex regions of the supporting bead face towards concave regions of the sealing bead. This may apply if the bead flank of the supporting bead that faces towards the sealing bead and the bead flanks of the sealing bead are in phase.

The separator plate is often a metal layer. In this case, the sealing bead and the supporting bead are usually integrally formed in the metal layer, a maximum embossing height of the supporting bead, measured perpendicular to the separator plate plane, being smaller than a maximum embossing height of the sealing bead at least in a non-compressed state of the separator plate. If a curvature is present, then the following may apply in the non-compressed state: height of the sealing bead>height of the supporting bead>height of the curvature. The non-compressed state is to be understood here to mean, for instance, a state in which the separator plate is not (yet) installed in a cell stack, or is stacked with cells and/or MEAs and GDLs to form a cell stack but the stack has not yet been compressed. These height ratios may apply both to a single-layer separator plate and to a separator plate which is part of a bipolar plate consisting of two separator plates.

Usually, the supporting bead projects out of the separator plate plane to the same extent as the sealing bead in a compressed state of the separator plate. This may apply both to the normal operating state and to states of higher compression, at least if neither of the two elements has undergone undesired irreversible deformation as a result of an impact, for example.

The supporting bead may for example have between the bead flanks a (virtual) center line which extends rectilinearly at least along the at least 2 wave periods of the sealing bead.

The main directions of extension of the sealing bead and the supporting bead may extend parallel to each other. Furthermore, a main direction of extension of the supporting bead may extend substantially parallel to an edge of the separator plate.

In another variant, a width period of the supporting bead is assigned to each period of the wavy course of the sealing bead.

The sealing bead is often configured as a port bead for sealing off a through-opening formed in the separator plate, or as a perimeter bead for sealing off a flow field of the separator plate.

The wavy course of the sealing bead may have at least 3, at least 10, and/or at least 20 periods. The latter two numbers may relate to perimeter beads. The periodically changing width of the supporting bead may also have at least 3 periods, at least 10, and/or at least 20 periods.

It may be provided that the supporting bead is arranged between the sealing bead and an edge of the separator plate, such as an outer edge which delimits an outer circumference of the separator plate or an inner edge which delimits a through-opening formed in the separator plate, and/or between two sealing beads.

By way of example, the supporting bead is arranged in a corner region or border region of the separator plate. By way of example, the supporting bead is arranged in a region which does not guide fluid during operation of the electrochemical system. In fuel cell systems, however, a supporting bead may also be arranged in a region which guides coolant.

According to another aspect of the present specification, a bipolar plate is provided. The bipolar plate comprises at least one, and/or two separator plates of the type described above. In a two-layer bipolar plate, the separator plates are connected to each other and are arranged in such a way that the undersides thereof face towards each other and the sealing beads and supporting beads of the two separator plates face with their bead tops away from each other.

In one embodiment, the two separator plates are connected to each other by means of at least one welded joint. The welded joint may extend between the supporting bead and the sealing bead, for instance centrally between the supporting bead and the sealing bead. For example, a sealing welded joint, e.g. a continuous welded joint or an uninterrupted welded joint composed of multiple welds, is arranged between the supporting bead and the sealing bead.

The separator plates are often at least in part connected to each other on both sides of the supporting bead by means of welded joints. In addition to a sealing welded joint between the supporting bead and the sealing bead, short weld lines or weld spots may be arranged on the other side of the supporting bead, for instance in the concave regions thereof or offset laterally in relation to said regions, these weld lines or weld spots preventing undesired deformation, for example of a border of the bipolar plate, under compression.

According to another aspect of the present specification, an electrochemical system is proposed. The electrochemical system comprises a plurality of separator plates of the type described above and/or a plurality of bipolar plates of the type described above. The separator plates and/or bipolar plates are stacked in a stack perpendicular to the separator plate planes. Depending on the application, electrochemical cells are arranged between the single-layer separator plates (for example in the case of electrolyzers) or between the two-layer bipolar plates (for example in the case of fuel cells). The electrochemical cells and the separator plates or bipolar plates are stacked in a stack perpendicular to the separator plate planes and are pressed together between end plates, optionally with the interposition of further components.

The advantages and further embodiments of the electrochemical system and of the bipolar plates largely correspond to the advantages and further embodiments described for the separator plates.

Exemplary embodiments of the separator plate, of the bipolar plate and of the electrochemical system are shown in the accompanying figures and will be explained in greater detail on the basis of the following description.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows, in a perspective view, an electrochemical system comprising a plurality of separator plates or bipolar plates arranged in a stack.

FIG. 2 schematically shows, in a perspective view, two bipolar plates of the system according to FIG. 1, each consisting of two separator plates, with a membrane electrode assembly (MEA) arranged between the bipolar plates.

FIGS. 3A and 3B, a plan view of a portion of a separator plate or bipolar plate in a first variation of the present disclosure and a section along the section line C-C;

FIG. 4 shows, in an oblique view, a portion of a separator plate as in FIG. 3A in the region of a supporting bead.

FIGS. 5A to 5E, schematic sectional views of the separator plate along the section lines A-A and B-B from FIG. 3A in four states of compression.

FIG. 6 shows a force-displacement characteristic graph of the supporting bead from FIG. 5.

FIG. 7 schematically shows a plan view of a separator plate in a further variation.

FIG. 8 schematically shows a plan view of a bipolar plate, consisting of two separator plates, in a further variation.

FIG. 9 schematically shows a plan view of a bipolar plate, consisting of two separator plates, in a further variation.

FIG. 10 schematically shows a plan view of a bipolar plate, consisting of two separator plates, in a further variation.

FIGS. 11A to 11D, plan views of separator plates with possible courses of supporting and sealing beads.

### DETAILED DESCRIPTION

Here and below, features that recur in different figures are denoted in each case by the same or similar reference signs. For the sake of clarity, the repetition of reference signs in the figures is sometimes omitted.

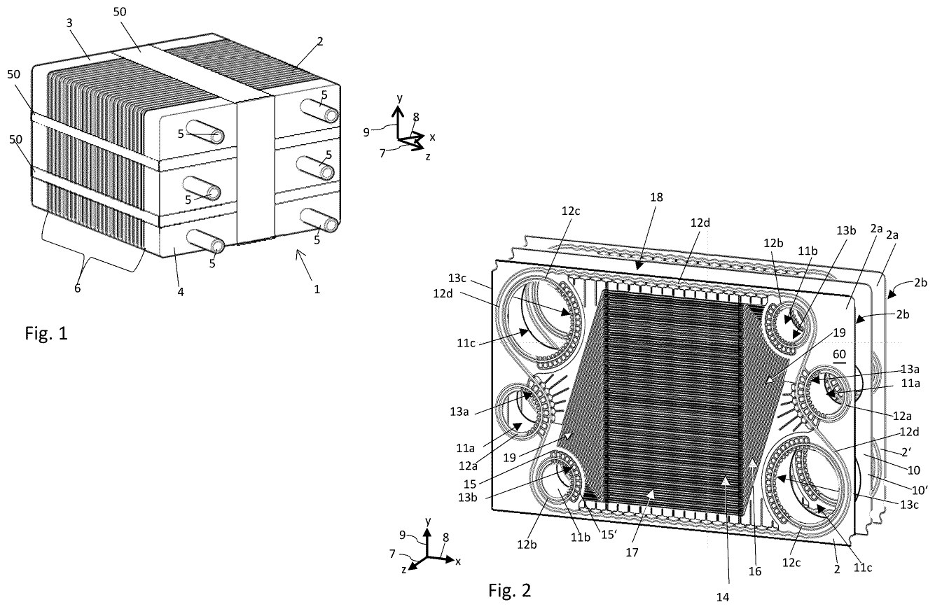

FIG. 1 shows an electrochemical system 1 comprising a plurality of structurally identical metal bipolar plates 2, which are arranged in a stack 6 and are stacked along a z-direction 7. The bipolar plates 2 of the stack 6 are clamped between two end plates 3, 4. Clamping may take place, for example, by way of straps 50 or tie-rods or tension plates (not shown here). A closure mechanism of the straps may be arranged on the end plate 3 and is not visible in the view shown. The z-direction 7 is also referred to as the stacking direction. In the present example, the system 1 is a fuel cell stack. Each two adjacent bipolar plates 2 of the stack thus bound an electrochemical cell, which serves for example to convert chemical energy into electrical energy. To form the electrochemical cells of the system 1, a membrane electrode assembly (MEA) 10 is arranged in each case between adjacent bipolar plates 2 of the stack (see, for example, FIG. 2). Each MEA 10 typically contains at least one membrane, for example an electrolyte membrane. The MEA 10 often additionally comprises a frame-like reinforcing layer, which frames the electrolyte membrane and reinforces it in the region of overlap with the actual electrolyte membrane. The reinforcing layer is usually electrically insulating and prevents a short-circuit from occurring during operation of the electrochemical system 1.

In alternative embodiments, the system 1 may also be designed as an electrolyzer, as an electrochemical compressor, or as a redox flow battery. Separator plates can also be used in these electrochemical systems. The structure of these separator plates may then correspond to the structure of the separator plates 2a, 2b of the bipolar plates 2 that are explained in detail here, although the media guided on and/or through the separator plates in the case of an electrolyzer, an electrochemical compressor or a redox flow battery may differ in each case from the media used for a fuel cell system, and optionally just one separator plate—e.g. not a bipolar plate consisting of two separator plates—is installed between two membranes located closest to each other.

The z-axis 7, together with an x-axis 8 and a y-axis 9, spans a right-handed Cartesian coordinate system. The bipolar plates 2 each define a plate plane, each of the plate planes of the separator plates being oriented parallel to the x-y plane and thus perpendicular to the stacking direction or to the z-axis 7. The end plate 4 usually has a plurality of media ports 5, via which media can be supplied to the system 1 and via which media can be discharged from the system 1. Said media that can be supplied to the system 1 and discharged from the system 1 may comprise for example fuels such as molecular hydrogen or methanol, reaction gases such as air or oxygen, reaction products such as water vapor or depleted fuels, or coolants such as water and/or glycol.

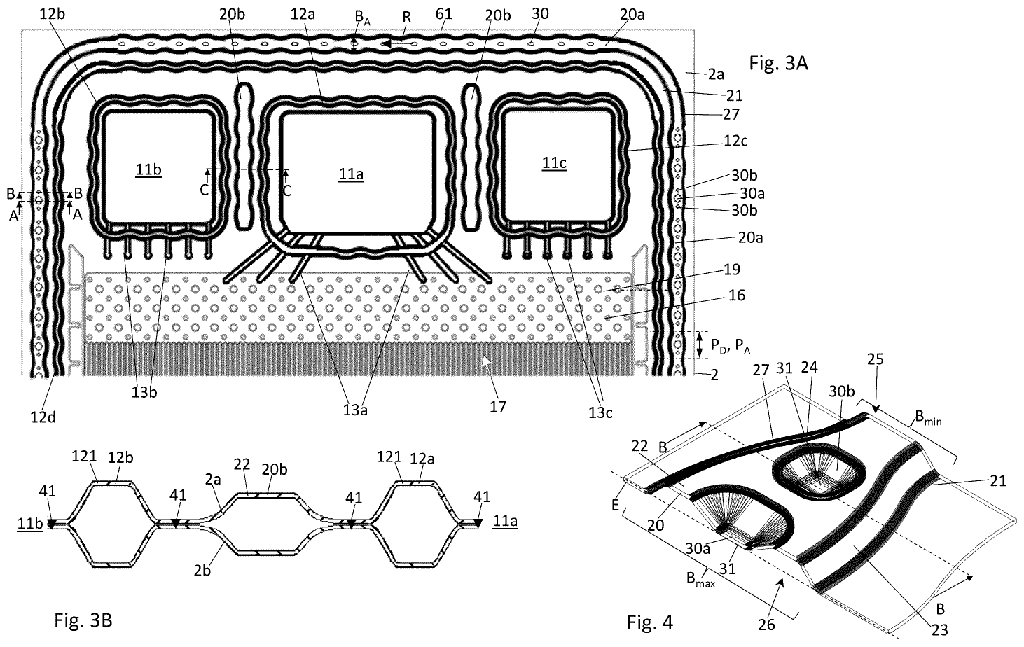

Both conventional bipolar plates 2, as shown in FIG. 2, and separator plates according to the present disclosure, or bipolar plates consisting thereof, as shown in FIG. 3 onwards, can be used in an electrochemical system as shown in FIG. 1.

FIG. 2 shows, in a perspective view, two adjacent bipolar plates 2, 2′, known from the prior art, of an electrochemical system of the same type as the system 1 from FIG. 1, as well as a membrane electrode assembly (MEA) 10 which is arranged between these adjacent bipolar plates 2 and is likewise known from the prior art, the MEA 10 in FIG. 2 being largely obscured by the bipolar plate 2 facing towards the viewer. The bipolar plate 2 is formed of two separator plates 2a, 2b which are joined together in a materially bonded manner, of which only the first separator plate 2a facing towards the viewer is visible in FIG. 2, said first separator plate obscuring the second separator plate 2b. The separator plates 2a, 2b may each be manufactured from a metal sheet, for example from an optionally (pre-)coated stainless steel sheet. The separator plates 2a, 2b may for example be welded to each other along their outer edge, for example by laser-welded joints.

The separator plates 2a, 2b typically have through-openings, which are aligned with each other and form through-openings 11a-c of the bipolar plate 2. When a plurality of bipolar plates of the same type as the bipolar plate 2 are stacked, the through-openings 11a-c form lines which extend through the stack 6 in the stacking direction 7 (see FIG. 1). Typically, each of the lines formed by the through-openings 11a-c is fluidically connected to one of the media ports 5 in the end plate 4 of the system 1. For example, coolant can be introduced into the stack 6 via the lines formed by the through-openings 11a, while the coolant is discharged from the stack 6 via other through-openings 11a. In contrast, the lines formed by the through-openings 11b, 11c may be designed to supply fuel and reaction gas to the electrochemical cells of the fuel cell stack 6 of the system 1 and to discharge the reaction products from the stack 6. The media-guiding through-openings 11a-c are substantially parallel to the plate plane.

In order to seal off the through-openings 11a-c with respect to the interior of the stack 6 and with respect to the surrounding environment, the first separator plates 2a each have sealing arrangements in the form of port beads 12a-c, which are arranged in each case around the through-openings 11a-c and in each case completely surround the through-openings 11a-c. On the rear side of the bipolar plate 2, facing away from the viewer of FIG. 2, the second separator plates 2b have corresponding port beads for sealing off the through-openings 11a-c (not shown). In cross-section, each sealing bead of a port bead 12a-12c may have at least one bead top and two bead flanks, but a substantially angular arrangement between these elements is not necessary; a curved transition may also be provided, e.g. beads that are arcuate in cross-section or beads that have a convex top are also possible.

Adjacent to an electrochemically active region 18 of the MEA, the first separator plates 2a have, on the front side thereof facing towards the viewer of FIG. 2, a flow field 17 with first structures 14 for guiding a reaction medium along the outer side (or also front side) of the separator plate 2a. In FIG. 2, these first structures 14 are defined by a plurality of webs and by channels extending between the webs and delimited by the webs. On the front side of the bipolar plates 2, facing towards the viewer of FIG. 2, the first separator plate 2a additionally has a distribution and collection region 19. The distribution and collection regions 19 comprise second structures 16 for guiding a reaction medium along the outer side (or also front side) of the separator plate 2a, these second structures being designed to distribute over the flow field 17 and thus over the active region 18 a medium that is introduced from a first of the two through-openings 11b into the adjacent distribution region 19 and to collect or to pool via the collection region 19 a medium flowing towards the second of the through-openings 11b from the flow region 17. In FIG. 2, the second structures 16, e.g. the structures of the distribution and collection region 19, are likewise defined by webs and by channels extending between the webs and delimited by the webs.

The port beads 12a-12c are crossed by conveying channels 13a-13c, which are in each case integrally formed in all the separator plates 2a, 2b, and of which the conveying channels 13a both on the underside of the upper separator plate 2a and on the upper side of the lower separator plate 2b form a connection between the through-opening 11a and the distribution region 19. By way of example, the conveying channels 13a enable coolant to pass between the through-opening 11a and the distribution and collection region 19, so that the coolant enters the distribution and collection region 19 between the separator plates 2a, 2b and is guided out therefrom.

The conveying channels 13b in the upper separator plate 2a and the conveying channels 13c in the lower separator plate 2b establish, together with apertures 15′ in the flanks of a connecting channel 15 connecting all the conveying channels 13b and 13c, a corresponding connection between the through-opening 11b or 11c and the respectively adjacent distribution or collection region 19. The conveying channels 13b thus enable hydrogen to pass between the through-openings 12b and the adjacent distribution or collection region on the upper side of the upper separator plate 2a. These conveying channels 13b adjoin apertures 15′—here in the flanks of the connecting channel 15—which face towards the distribution or collection region and which extend at an angle to the plate plane, through which apertures the hydrogen can flow. Conveying channels 13c, together with apertures 15′ in the flanks of the connecting channel 15, enable air, for example, to pass between the through-opening 12c and the distribution or collection region on the rear side of the bipolar plate 2, so that air enters the distribution or collection region on the underside of the lower separator plate 2b and is guided out therefrom (not visible in FIG. 2). Possible further embodiments of the conveying channels and apertures are disclosed, for example, in the above-mentioned documents DE 20 2022 101 861, DE 20 2015 104 972, DE 20 2015 104 973 and DE 102 48 531 A1.

The first separator plates 2a each also have a further sealing arrangement in the form of a perimeter bead 12d, which extends around the flow field 17 of the active region 18 and also around the distribution or collection regions 19 and the through-openings 11b, 11c and seals these off with respect to the environment surrounding the system 1 and, together with the port beads 12a, with respect to the through-openings 11a, e.g. with respect to the coolant circuit. The second separator plates 2b each comprise corresponding perimeter beads 12d. The structures of the flow region 17, the distributing or collecting structures of the distribution or collection region 19 and the sealing beads 12a-d are each formed in one piece with the separator plates 2a and are integrally formed in the separator plates 2a, for example in an embossing, hydroforming or deep-drawing process. The same applies to the corresponding flow fields, distributing structures and sealing beads of the second separator plates 2b.

While the port beads 12a-12c have a substantially round course, which nevertheless depends primarily on the shape of the associated through-opening 11a-11c, the perimeter bead 12d has various portions that are shaped differently. For instance, the course of the perimeter bead 12d may include at least two wavy portions, and the port beads 12a-12c may also extend at least in part in a wavy manner.

As mentioned above, the present disclosure has been designed to protect separator plates compressed in a stack, and the sealing beads 12a-12d thereof, against permanent deformation in the event of a crash. For this purpose, additional structures—namely supporting beads—are provided, which make it possible to absorb the impact energy. In the subsequent FIGS. 3-11, the sealing beads are shown with a flat bead top, but this is not necessary, e.g. the sealing bead may also have a bead top that is arcuate in cross-section, as shown in DE 10 2009 012 730 A1 for the prior art and the respective upper separator plate.

FIG. 3A shows a plan view of a portion of a separator plate 2a, for an electrochemical system 1, as shown in FIG. 1, which forms the layer of a bipolar plate 2 that faces towards the viewer. As in FIG. 2, three through-openings 11a-11c for media are provided, which can be fluidically connected via conveying channels 13a-13c to the distribution or collection region 19, which in turn is fluidically connected to the flow field 17 located opposite the active region of the MEA (not shown). The through-openings 11a-11c are each sealed off from the outside individually by means of port beads 12a-12c, and jointly with the distribution and collection regions 19 and the flow field 17 by means of the perimeter bead 12d. The separator plate 2a of FIG. 3A differs from that of FIG. 2 on the one hand by different shapes of the through-openings 11a-11c, by a modified routing of the perimeter bead 12d, which here encloses all the through-openings 11a-11c, and by the nub-like second structures 16 of the distribution or collection region 19. With regard to these elements, however, separator plates 2a or bipolar plates 2 according to the present disclosure may also be designed as shown in FIG. 2.

On the other hand, the separator plate 2a of FIG. 3A and the separator plate 2a of FIG. 2 differ by the additional supporting beads 20a, 20b, which are shown only in the embodiment according to the present disclosure in FIG. 3A.

The separator plate 2a of FIG. 3A thus has at least one sealing bead 12, specifically the port beads 12a-12c and the perimeter bead 12d, for sealing off from the outside a region of the separator plate, namely the through-openings 11a-c or the entire region of the separator plate. Each of these sealing beads has at least in part a wavy course with at least two wave periods, each having a period length P_{D}, but may be designed without such wave structures in its corner regions. Furthermore, the separator plate 2a of FIG. 3A has at least one supporting bead 20, specifically the supporting beads 20a, 20b, which may, in a crash situation or in the event of some other kind of impact, support the sealing beads 12a-d and may protect them against excessive deformation. The supporting beads 20a, 20b are spaced apart from the sealing beads 12a-d and extend along the wavy course of the respective sealing bead. The supporting beads 20a, 20b have a periodically changing, non-vanishing width B_{A} with at least two periods, each having a period length P_{A}. Here, the period lengths P_{A} of the width period at least of the supporting bead 20a and the period length P_{D} of the sealing bead 12d are substantially equal. The width B_{A} of the supporting bead is measured perpendicular to the direction of extension R of the supporting bead and from a first outer bead foot 21 to a second outer bead foot 27 of the supporting bead 20. Here, the “outer bead foot” refers to that point, on the side of the separator plate towards which the supporting bead and the sealing bead are curved, in the cross-section through the supporting bead, at which the metal sheet leaves the plane and transitions into a radius.

The supporting beads 20a, 20b each have two bead flanks 23, 24 which rise upwards from said bead feet 21, 27 and between which a bead top 22 extends, as is also clear from FIG. 4. While the supporting beads 20b of FIG. 3A have a bead top which extends in a substantially planar manner between the bead flanks 23, 24, the bead top 22 of the supporting bead 20a has a first portion which is likewise substantially planar, while at least one curvature 30, 30a, 30b relative to the separator plate plane E is formed in a second portion. The curvature 30, 30a, 30b may also be described as a depression, indentation, deformation, or concavity. The depicted curvature 30, 30a, 30b is configured as a depression in the bead top 22 and will be referred to as depression 30, 30a, 30b. Instead of a planar top 22, the supporting beads 20a, 20b may also be slightly convexly curved or domed away from the separator plate plane E in the aforementioned first portion. In contrast to the convex shape in the first portion, the depressions 30, 30a, 30b may be interpreted as a concave portion of the top 22.

In FIG. 3A, a respective supporting bead 20b is arranged between the port beads 12b and 12a on the one hand and between the port beads 12a and 12c on the other hand. The section from the through-opening 11b to the through-opening 11a along the section line C-C in FIG. 3A is shown in FIG. 3B. It is clear therefrom that the supporting bead 20b is lower than the two sealing beads 12a and 12c. FIG. 3B shows the two separator plates 2a, 2b, which are connected to each other and the undersides of which face towards each other, while the sealing beads 12 and supporting beads 20 of the two separator plates 2a, 2b point with their bead tops 22, 121 away from each other.

Here, the two separator plates 2a, 2b are connected to each other by means of a welded joint 41 which extends in part between the supporting bead 20 and the sealing bead 12, more precisely centrally between the supporting bead 20 and the sealing bead 12. The welded joints 41 extend at least in part on both sides of the supporting bead 20.

As already mentioned, the width B_{A} of the supporting bead varies between a minimum width and a maximum width. A depression 30 may be arranged in the region of the maximum width of the supporting bead. If, on the other hand, depressions 30a, 30b of different size are provided, as shown on the portions of the supporting bead 20a extending along the distribution region 19 and the flow field 17 in FIG. 3A, the largest and/or highest depressions 30a, in terms of the projection area thereof into the separator plate plane, may be arranged in the region 26 of the maximum width of the supporting bead. In contrast, in the region 25 of the minimum width of the supporting bead, the bead top 22 may be planar, e.g. is formed without curvatures, or at most is slightly convexly curved or domed, as also shown in FIG. 4. FIG. 4 shows a portion of a supporting bead 20 in an oblique view. The portion corresponds to half a period length P_{A} of the supporting bead; it extends from a region 26 of maximum width Bₘₐₓ to a region 25 of minimum width Bₘᵢₙ. It may be that a curvature relative to the separator plate plane extends at most over a region spanned by a single period of the periodically changing width of the wavy course of the supporting bead 20, e.g. at most over one period length P_{A}. Furthermore, the bead top of the supporting bead may have at least two curvatures relative to the separator plate plane, for instance at least two curvatures per width period. The two curvatures may have different embossing depths and/or different dimensions and/or different geometric shapes. In FIG. 4, the supporting bead 20 has one complete small depression 30b—small both in terms of its surface area and its depth—and half of one large depression 30a—large both in terms of its surface area and its depth—per half a period length.

Extended symmetrically, there are therefore two small depressions 30b and one large depression 30a per one whole period length.

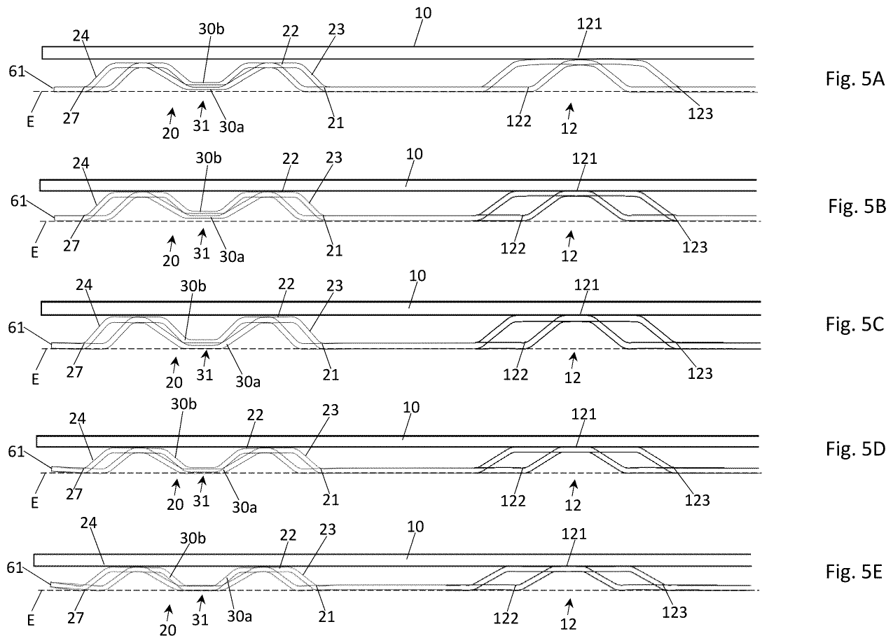

FIG. 5 shows, in five sub-figures 5A-5E, how the geometry of a portion of a supporting bead 20 and of a sealing bead 12, which extends adjacent to this supporting bead and is spaced apart therefrom, varies as compression increases. Shown in each case is a separator plate 2a, which is configured as a metal layer and lies on the separator plate plane E. In a bipolar plate 2 comprising two separator plates 2a, 2b, this separator plate plane E in the region shown corresponds to a mirror plane between the two separator plates 2a, 2b. Sub-figures 5A-5E respectively show sections along the section line A-A and the section line B-B in FIG. 3A and along the cross-section of FIG. 4 facing towards the viewer of FIG. 4, as well as a section along the section line B-B also denoted therein. A section line through the larger depression 30a, which is shown in section in FIG. 4, and a section line through the small depression 30b, which is shown only in an oblique view in FIG. 4, are therefore shown in each case. The sectional views of FIG. 5 thus show in each case a sealing bead 12 and a supporting bead 20, which are integrally formed in the metal layer. For the sake of clarity, bead feet 21, 27 and bead flanks 23, 24 have been provided with reference signs only for the section line of the larger depression 30a. Analogously, two sections are also shown for the sealing bead. Adjacent to the supporting bead, the rising flank of the sealing bead in the section plane B-B is shown first, followed to the right by the rising flank of the sealing bead in the section plane A-A, then by the falling flank of the sealing bead in the section plane B-B, and finally, shown on the far right, the falling flank of the sealing bead in the section plane A-A.

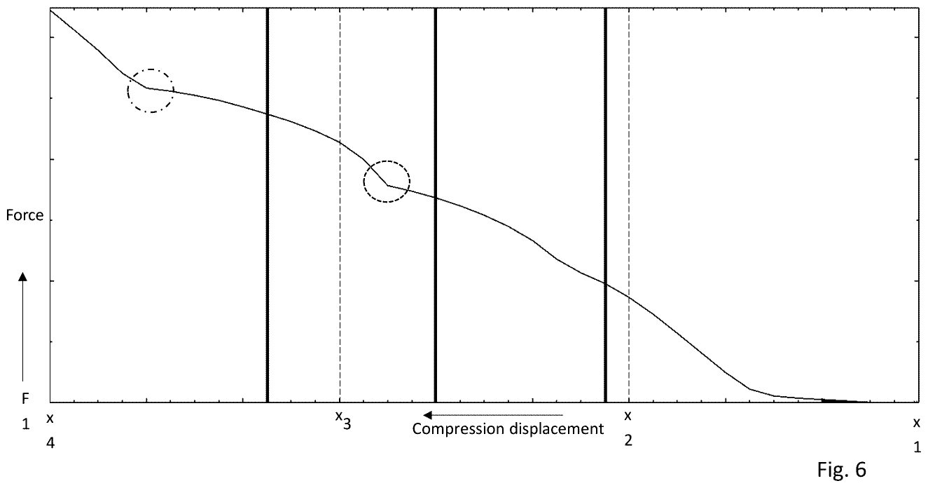

FIG. 5A shows the state prior to compression: The sealing bead 12 is clearly larger than the supporting bead 20, and the reinforcing border of the MEA 10—hereinafter simply referred to also as the MEA 10—lies loosely on the sealing bead. The height of the supporting bead 20 is unable to bridge the distance—shown in idealized form—between the separator plate plane E and the MEA 10. The depressions 30a, 30b are projected into each other with different heights and widths and in this non-compressed state of the separator plate 2a, 2b are spaced apart from the separator plate plane E. In this non-compressed state of the separator plate 2a, the maximum embossing height of the supporting bead 20, measured perpendicular to the separator plate plane E, is smaller than a maximum embossing height of the sealing bead 12. Also, the central region 31 of the portion 30a comprises a smaller depth than the height of the portion 30a with respect to the separator plate plane E. FIG. 5B shows the state under normal operating conditions, e.g. already a first compressed state. Both the sealing bead 12 and the supporting bead 20 bear with their respective top 121, 22 against the MEA 10, the feet 122, 123 of the sealing bead 12 and also the bead feet 21, 27 lie in the separator plate plane E or directly adjoin the latter, and the height of the sealing bead 12 and the supporting bead 20 is in each case x₁. In this compressed state, which corresponds to the usual operating conditions, the supporting bead 20 therefore projects out of the separator plate plane E to the same extent as the sealing bead 12. The depressions 30a, 30b are in contrast spaced apart from the separator plate plane E. This is also the compression state that is shown on the far right in the force-displacement characteristic curve of FIG. 6. The sealing bead 12 is elastically compressed to the height of the supporting bead 20, e.g. it has absorbed the force resulting from the clamping of the plate stack and can also spring back from this state to the extent that the clamping elements allow. In contrast, the supporting bead 20 has not yet undergone any compression at all or only marginal compression, e.g. it has not yet been substantially deformed compared to FIG. 5A. FIG. 5C shows a state in which slightly more force acts on the separator plate 2a. Now both the sealing bead 12 and the supporting bead 20 are compressed to a height x₂. The lowest region, also referred to as the central region 31, of the larger curvature has reached the separator plate plane E, e.g. also has the height x₂. This state corresponds to the dashed line on the right in the force-displacement characteristic curve of FIG. 6. During the compression from x₁ to x₂, the supporting bead increasingly absorbs force, but also provides increasing resistance to further compression, as can be seen from the rising curve in FIG. 6 for this region. During further compression of the separator plate 2a to a height x₃ , e.g. in the state shown in FIG. 5D, the sealing bead 12, the supporting bead 20 and the first depression 30a all undergo a compression, e.g. the sealing bead 12 and the supporting bead 20 undergo a further compression. Even here, the second depression 30b does not yet bear against the separator plate plane E. The kink indicated by a dashed circle in the force-displacement curve of FIG. 6 highlights the point at which the first depression 30a also begins to absorb force, contributing to the overall stiffness. During further compression to a height x₄, the second curvature also first comes to bear and then is also compressed, which in the force-displacement characteristic curve of FIG. 6 is shown by the kink indicated by a dash-dotted circle and a further increase in force absorption. In this strongly compressed state of the separator plate 2a, the depressions 30a, 30b therefore lie at least in part in the separator plate plane E. In contrast, due to the force absorption by the supporting bead 20 and the depressions 30a, 30b, the sealing bead 12 has absorbed only a small proportion of the e.g. impact-induced force. Therefore, despite the energy absorbed, the sealing bead 12, the supporting bead 20 and the depressions 30a, 30b are all within an elastic compression range, so that they can spring back to their original state without any significant plastic deformation.

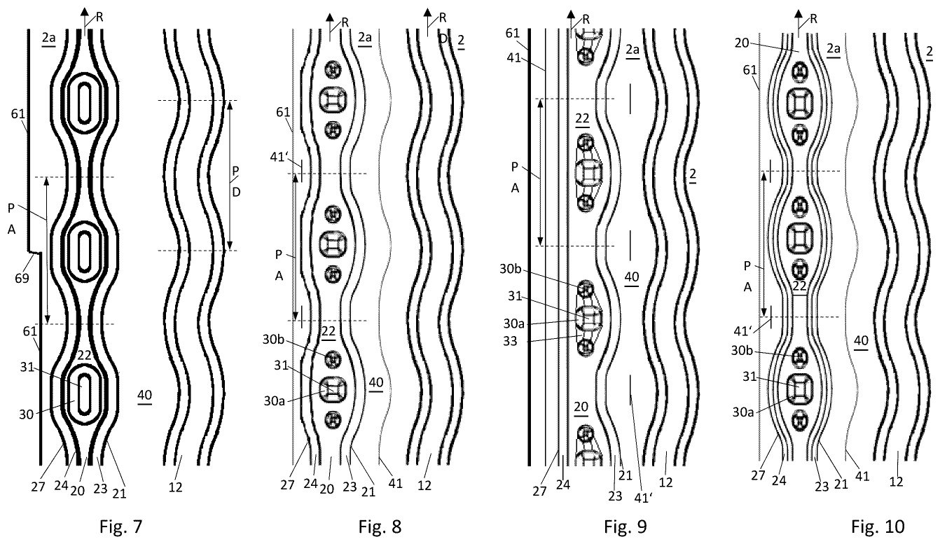

FIG. 7 shows a plan view of a portion of a separator plate 2a adjacent to the side edge 61 of this separator plate 2a. Extending between the side edge 61 and the wavy sealing bead 12 is a supporting bead 20, which in the entire area shown has a periodically changing, non-vanishing width B_{A} with the same number of periods as the wavy sealing bead. The supporting bead consistently has one depression 30 per period length P_{A}. Compared to the horizontally extending supporting bead in FIG. 3, the depressions 30 here are much larger; they extend over approximately ⅓ of the period length and have a maximum width that corresponds to approximately ⅔ of the maximum width of the bead top 22. The supporting bead 20 together with its depressions 30 is mirror-symmetrical with respect to its main direction of extension R. Although the supporting bead 20 does not correspond to a sinusoidal wave in terms of its width periodicity, the period length P_{A} thereof is equal to the period length P_{D} of the sealing bead 12. The first bead flank 23 of the supporting bead 20 has the same phase as the waveform of the sealing bead 12, while its second bead flank 24 has a phase shifted by 180° relative thereto. As a result, concave regions of the supporting bead 20 face towards convex regions of the sealing bead 12 and convex regions of the supporting bead 20 face towards concave regions of the sealing bead 12. In the example of FIG. 7, the side edge 61 is provided with a recess 69, which may serve, for example, to accommodate a clamping strap 50, as shown in FIG. 1.

FIG. 8 shows a plan view of a portion of a separator plate 2a of a bipolar plate 2, again adjacent to the side edge 61. The supporting bead 20 here has an asymmetry; the change in width is more pronounced adjacent to the first bead flank 23 than adjacent to the second bead flank 24. This enables better use of the installation space. The depressions 30a, 30b are substantially comparable to those in FIG. 4. The two separator plates of the bipolar plate 2 are sealingly connected to each other by means of a continuous weld 41 in the region 40 between the supporting bead 20 and the sealing bead 12. The weld 41 extends centrally between the sealing bead 12 and the supporting bead 20 in a wavy manner with the same period length and the same phase as the flanks of the sealing bead 12 and the first flank 23 of the supporting bead 20. This makes it possible to minimize the necessary spacing between the supporting bead 20 and the sealing bead 12. In addition, the separator plates of the bipolar plate 2 are connected by means of short weld portions 41′ adjacent to the side edge 61 and adjacent to the concave regions of the second bead flank 24.

This makes it possible to avoid any bending of the side edge 61 under stronger compression, as shown in FIGS. 5D and 5E for a separator plate without such a weld 41′. As in FIG. 7, the main direction of extension R_{D} of the sealing bead 12 and the main direction of extension R of the supporting bead 20 extend parallel to each other and substantially also parallel to the adjacent edge 61 of the separator plate 2a.

FIG. 9 shows a plan view of a portion of another separator plate 2a of a bipolar plate 2, likewise adjacent to the side edge 61. Here, the supporting bead 20 is asymmetrical, so that only the first bead flank 23 has a wavy course, while the second bead flank 24 extends rectilinearly and parallel to the side edge 61. The supporting bead 20 nevertheless still has a periodically changing, non-vanishing width B_{A}. Such a solution may be for space reasons; it also enables the two separator plates to be continuously welded in a space-saving manner along the side edge 61 by means of the weld 41. To avoid undesired elevations in the region 40 between the supporting bead 20 and the sealing bead 12 under strong compression, welds 41′ may additionally be provided in this region. Here, in a manner similar to FIGS. 4 and 8, the supporting bead 20 has three depressions 30a, 30b per period length, some of said curvatures being of different geometry. While the large depressions 30a are formed substantially centrally in the region of the supporting bead, as before, the small depressions 30b are shifted a little towards the second bead flank 24. The region 33 between these curvatures does not reach the level of the bead top 22; instead, it is lowered somewhat compared to the bead top 22, but this lowering is less than that of the smaller depressions 30b. These altered geometries enable an even more targeted adjustment of the stiffness of the effective unit consisting of the sealing bead 12, the supporting bead 20 and the depressions 30a, 30b. As an alternative to the combination consisting of the depressions 30a, 30b and the intermediate region 33, it is also possible, for example, for a single curvature with a sloping bottom to be integrally formed in the separator plate.

FIG. 10 shows a plan view of a portion of another separator plate 2a of a bipolar plate 2, again adjacent to the side edge 61. The embodiment is similar to that of FIG. 8. However, the small depressions 30b are now not circular, but instead have a greater extension along the main direction of extension R than in a direction perpendicular to said direction. This enables a further adjustment of the stiffness. In a manner differing from FIG. 8, the supporting bead 20 is mirror-symmetrical. Furthermore, the bead flanks 23, 24 of the supporting bead 20 each have two regions of different slope. Such a design of the bead flanks of a supporting bead enables a further fine adjustment of the compression behavior, as explained in the as yet unpublished utility model application DE 20 2022 106 505.5. The content of said document is fully incorporated in the present specification by way of reference.

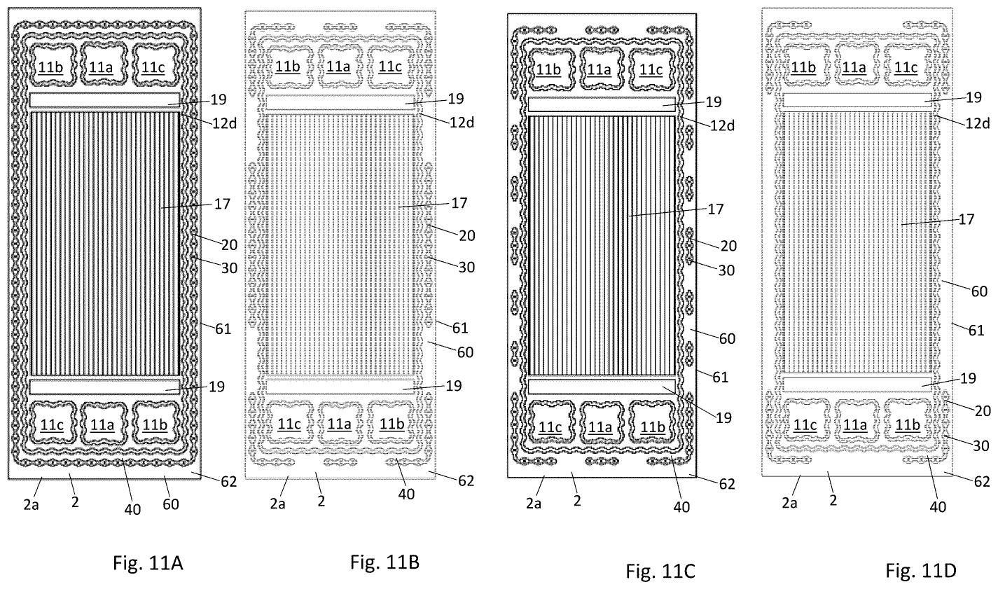

The supporting beads 20a, 20b may be used jointly in a separator plate, as shown in FIG. 3A. However, it is also possible to use only supporting beads 20a, for example supporting beads with curvatures, and/or supporting beads 20b, for example supporting beads without curvatures, in a separator plate 2a or bipolar plate 2. FIGS. 11A to 11D show different arrangements of supporting beads 20 in separator plates 2a or bipolar plates 2. In each case, the supporting bead 20 extends along the circumferential sealing bead 12d, in a manner spaced apart therefrom, and even extends predominantly parallel to this perimeter bead 12d with regard to its main direction of extension. The sealing bead 12d has at least in part a wavy course with at least two wave periods. However, the wavy course is interrupted in the corner regions 62. The wavy course of the perimeter bead 12d has more than three or more than ten periods along a side edge 61, and even more than 20 periods and more than 30 wave periods on the longer sides. While the supporting bead 20 in FIG. 11A is configured in such a way that, along the entire course of all the side edges 61, it has a periodically changing, non-vanishing width with at least two periods, it may also extend only in part along the side edges 61, as shown in schematic plan views of separator plates 2a or bipolar plates 2 in FIGS. 11B to 11D. In FIG. 11A, the periodically changing width of the supporting bead extends over more than three periods, more than ten periods, and on the long side edges even more than 20 periods. In all four embodiments, in the regions 40 between the sealing bead 12d and the supporting bead 20, the separator plate 2a extends in a substantially planar manner and parallel to the separator plate plane E and has no embossed structures.

In FIG. 11B, the supporting bead is arranged between a side edge 61, which delimits an outer circumference of the separator plate 2a, and the sealing bead 12d and extends around part of the circumference, for example in the corner regions 62 and in each case along the middle of the side edges 61 of the separator plate 2a. In FIG. 11C, the supporting bead 20 in the outer border region 60 consists of many short portions as well as longer portions which extend in the corner regions. Each of these portions extends over at least two periods of the periodically changing width. In contrast, in the embodiment of FIG. 11D, the course of the supporting bead 20 is substantially limited to the corner regions 62.

FIGS. 1-11D are shown approximately to scale. FIGS. 1-11D show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, having a separator plate plane, comprising:
a sealing bead for sealing off a region of the separator plate, the sealing bead having at least in sections a wavy course with at least two wave periods, and
a supporting bead for supporting the sealing bead,
wherein the supporting bead is spaced apart from the sealing bead and extends along the wavy course of the sealing bead,
wherein the supporting bead has a periodically changing, non-vanishing width with at least two periods, the width of the supporting bead being measured perpendicular to the direction of extension of the supporting bead and from a first outer bead foot to a second outer bead foot of the supporting bead.

2. The separator plate according to claim 1, wherein the supporting bead comprises two bead flanks, which start from said bead feet, and a bead top, which extends between the bead flanks of the supporting bead, the bead top being substantially planar or convex relative to the separator plate plane in a first portion and having at least one a depression in the bead top.

3. The separator plate according to claim 2, wherein the width of the supporting bead varies between a minimum width and a maximum width, the depression being arranged in the region of the maximum width of the supporting bead and/or the bead top being planar or convex relative to the separator plate plane in the region of the minimum width.

4. The separator plate according to claim 2, wherein the depression extends at most in a region spanned by a single period of the periodically changing width of the supporting bead.

5. The separator plate according to claim 2, wherein the bead top has at least two depressions, said depressions having different embossing depths and/or different dimensions and/or different geometric shapes.

6. The separator plate according to claim 2, wherein the depression is at least in part spaced apart from the separator plate plane at least in a non-compressed state of the separator plate and/or at least in part lies in the separator plate plane in a compressed state of the separator plate.

7. The separator plate according to claim 1, wherein the wave periods of the sealing bead and the width periods of the supporting bead have the same period length and/or the same phase and/or a phase shifted substantially by 180°.

8. The separator plate according to claim 1, wherein concave regions of the supporting bead face towards convex regions of the sealing bead and/or convex regions of the supporting bead face towards concave regions of the sealing bead.

9. The separator plate according to claim 1, wherein the separator plate is a metal layer, and the sealing bead and the supporting bead are integrally formed in the metal layer, a maximum embossing height of the supporting bead, measured perpendicular to the separator plate plane, being smaller than a maximum embossing height of the sealing bead at least in a non-compressed state of the separator plate.

10. The separator plate according to claim 1, wherein the supporting bead projects out of the separator plate plane to the same extent as the sealing bead in a compressed state of the separator plate.

11. The separator plate according to claim 1, wherein the main directions of extension of the sealing bead and the supporting bead extend parallel to each other, and/or wherein a main direction of extension of the supporting bead extends substantially parallel to an edge of the separator plate.

12. The separator plate according to claim 1, wherein the wavy course of the sealing bead has at least 3 periods, and/or wherein the periodically changing width of the supporting bead has at least 3 periods.

13. A bipolar plate, comprising two separator plates according to claim 1, which are connected to each other and are arranged in such a way that the undersides thereof face towards each other and the sealing beads and supporting beads of the two separator plates face with their bead tops away from each other.

14. The bipolar plate according to claim 13, wherein the two separator plates are connected to each other by means of at least one welded joint, the welded joint extending between the supporting bead and the sealing bead.

15. The bipolar plate according to claim 13, wherein the separator plates are at least in part connected to each other on both sides of the supporting bead by welded joints.

16. An electrochemical system comprising a plurality of separator plates according to claim 1, which are stacked in a stack perpendicular to the separator plate planes.
